(19) United States
(12) Patent Application Publication
(10) Pub. No.: US 2022/0169474 A1
(43) Pub. Date: Jun. 2, 2022

(54) MEDIUM LOADING DEVICE AND RECORDING SYSTEM

(71) Applicant: Seiko Epson Corporation, Tokyo (JP)

(72) Inventors: Masaki NAMIKI, Kitakyushu-shi (JP); Shun ITO, Matsumoto-shi (JP); Haruna TAKAHASHI, Ina-shi (JP); Mio YASHITA, Shiojiri-shi (JP)

(21) Appl. No.: 17/534,787

(22) Filed: Nov. 24, 2021

(30) Foreign Application Priority Data
Nov. 27, 2020 (JP) 2020-196890

(51) Int. Cl. B65H 31/26; B41J 15/04; B65H 29/26

(52) U.S. Cl. CPC B65H 31/26; B65H 29/26; B41J 15/042

(57) ABSTRACT

A loading device includes a placement portion and a correction portion. The placement portion is provided at a device main body, and a single paper sheet discharged from a discharge unit is placed on the placement portion. The correction portion is disposed downstream of the placement portion in a discharge direction, and corrects curling of the single paper sheet by coming into contact with the single paper sheet moving in the discharge direction from the placement portion. Furthermore, the correction portion includes a contact surface that extends in an intersecting direction intersecting the discharge direction and comes into contact with the single paper sheet, such that the position of the correction portion in the vertical direction becomes lower from upstream to downstream in the discharge direction.

The present application is based on, and claims priority from JP Application Serial Number 2020-196890, filed Nov. 27, 2020, the disclosure of which is hereby incorporated by reference herein in its entirety.

### BACKGROUND

### 1. Technical Field

The present disclosure relates to a medium loading device and a recording system.

### 2. Related Art

A recording medium receiving device disclosed in JP-A-2002-211821 receives, using a sheet member, a relatively large printing sheet discharged after recording.

As in the device disclosed in JP-A-2002-211821, in a device in which the large medium, which is relatively long in a discharge direction, is discharged onto a placement portion, a portion of the medium may protrude toward a downstream side from a downstream end portion, in the discharge direction, of the placement portion.

Here, a downstream portion of the large medium discharged onto the placement portion may curl in a cylindrical manner in an upward direction, which is a direction in which end portion positions in the width direction of the medium move away from the placement portion. If this downstream portion passes over the placement portion while being curled into the cylindrical shape, the downstream portion hangs downward under its own weight, and the curled portion ends up becoming folded over. In this case, the downstream end portion of the subsequently discharged medium may become caught up on the folded over portion of the previously discharged medium, and there is a risk that a stacking failure may occur.

### SUMMARY

A medium loading device according to the present disclosure for solving the above-described problem is a medium loading device on which is loaded a medium discharged from a discharge unit of a processing device. The medium loading device includes a placement portion provided at a device main body and on which at least one sheet of the medium discharged from the discharge unit is placed, and a correction portion disposed downstream of the placement portion in a movement direction, at the placement portion, of the medium, and configured to correct curling of the medium by coming into contact with the medium moving in the movement direction from the placement portion. The correction portion includes at least one contact surface extending in an intersecting direction intersecting the movement direction and configured to come into contact with the medium so that a position of the correction portion in a device height direction is lower from upstream to downstream in the movement direction.

A recording system according to the present disclosure for solving the above-described problem includes a recording device and a medium loading device. The recording device includes a storage unit configured to store roll paper, a transport unit configured to transport the roll paper from the storage unit, a recording unit configured to perform recording on the roll paper transported by the transport unit, a cutting unit configured to cut the roll paper, on which recording was performed by the recording unit, to form a single paper sheet as a medium, and a discharge unit configured to discharge the single paper sheet. The medium loading device includes a placement portion on which at least one of the single paper sheets discharged from the discharge unit is placed, and a correcting portion disposed downstream of the placement portion in a movement direction of the single paper sheet at the placement portion, and configured to correct curling of the single paper sheet by coming into contact with the single paper sheet moving in the moving direction from the placement portion. The correction portion includes at least one contact surface extending in an intersecting direction intersecting the movement direction and configured to come into contact with the single paper sheet so that a position of the correction portion in a device height direction becomes lower from upstream toward downstream in the movement direction.

### BRIEF DESCRIPTION OF THE DRAWINGS

FIG. 1 is an overall configuration diagram of a recording system according to a first embodiment.

FIG. 2 is a perspective view illustrating a portion of a loading device according to the first embodiment.

FIG. 3 is a perspective view illustrating a portion of the loading device according to the first embodiment.

FIG. 4 is a side view illustrating a state in which a rotating portion and a correction portion are rotated in the loading device according to the first embodiment.

FIG. 5 is a schematic diagram illustrating an arrangement relationship between a placement portion, an opposing portion, and the correction portion in a loading device according to a modified example of the first embodiment.

FIG. 6 is a side view illustrating a state in which curling of a tip portion of a single paper sheet is corrected by the correction portion in the loading device according to the first embodiment.

FIG. 7 is a front view illustrating a state in which curling of the tip portions of the single paper sheet is corrected by the correction portions in the loading device according to the first embodiment.

FIG. 8 is a schematic diagram illustrating an arrangement relationship between the placement portion, the opposing portion, and a correction portion in a loading device according to a second embodiment.

FIG. 9 is a schematic diagram illustrating an arrangement relationship between the placement portion, the opposing portion, and the correction portion in a loading device according to a third embodiment.

FIG. 10 is a schematic diagram illustrating an arrangement relationship of the placement portion, the opposing portion, and the correction portion in a loading device according to a modified example of the second embodiment.

### DESCRIPTION OF EXEMPLARY EMBODIMENTS

An overview of first to thirteenth aspects of the present disclosure will be described below.

A medium loading device according to a first aspect of the present disclosure for solving the above-described problem is a medium loading device on which is loaded a medium discharged from a discharge unit of a processing device. The medium loading device includes a placement portion provided at a device main body and on which at least one sheet of the medium discharged from the discharge unit is placed, and a correction portion disposed downstream of the placement portion in a movement direction, at the placement portion, of the medium, and configured to correct curling of the medium by coming into contact with the medium moving in the movement direction from the placement portion. The correction portion includes at least one contact surface extending in an intersecting direction intersecting the movement direction and configured to come into contact with the medium so that a position of the correction portion in a device height direction is lower from upstream toward downstream in the movement direction.

According to this aspect, when a portion of the medium moving on the placement portion is in a curled state in which a portion of the medium is curled up in the device height direction, and protrudes further downstream than the placement portion, the portion of the medium comes into contact with the contact surface of the correction portion. Here, since the contact surface extends in the intersecting direction so that the position thereof in the device height direction becomes lower from upstream to downstream in the movement direction, the portion of the medium that has come into contact with the contact surface is corrected in a direction opposite to the curling-up direction. As a result, when the portion of the medium protruding from the placement portion hangs down under its own weight, the portion of the medium is inhibited from becoming folded over. Thus, when the next medium is placed on the placement portion, it is possible to suppress a stacking failure in which the next medium becomes caught up on the previous medium.

Furthermore, according to this aspect, the stacking failure of the medium can be suppressed even when the length in the movement direction of the placement portion is caused to be shorter than the length in the movement direction of the medium. Thus, the placement portion can be downsized.

In the medium loading device according to a second aspect, with respect to the first aspect, the device main body includes an opposing portion disposed above the placement portion in the device height direction and facing the placement portion, and the correction portion is provided at the opposing portion.

According to this aspect, by providing the correction portion at the opposing portion of the device main body, the correction portion is supported by the opposing portion. Thus, it is not necessary to separately prepare a member for supporting the correction portion.

In the medium loading device according to a third aspect, with respect to the second aspect, a position of a downstream end portion in the movement direction of the opposing portion is aligned with a position of a downstream end portion of the placement portion in the movement direction, and the correction portion is provided at a downstream end of the opposing portion in the movement direction.

According to this aspect, the position of the downstream end portion of the placement portion and the position of the downstream end portion of the opposing portion are aligned in the movement direction. As a result, the portion of the medium protruding from the placement portion does not come into contact with the opposing portion, but comes into contact with the correction portion. As a result, the curling can be corrected at an early stage with respect to the portion of the medium protruding from the placement portion.

In the medium loading device according to a fourth aspect, with respect to any one of the first to third aspects, in the device height direction, a height position of a downstream end portion of the correction portion in the movement direction is aligned with a height position of a downstream end portion of the placement portion in the movement direction.

According to this aspect, the height position of the downstream end portion of the correction portion is aligned with the height position of the downstream end portion of the placement portion. Thus, when the medium having a relatively high rigidity in which the curling is unlikely to occur is discharged and the medium is moved downstream from the placement portion in a substantially straight manner, even if the medium comes into contact with the correction portion, the medium easily passes over the correction portion. In other words, when the medium having the relatively high rigidity is used, it is possible to inhibit the medium from becoming caught up on the correction portion.

In the medium loading device according to a fifth aspect, with respect to any one of the first to third aspects, in the device height direction, a height position of a downstream end portion of the correction portion in the movement direction is positioned below a height position of a downstream end portion of the placement portion in the movement direction. According to this aspect, since the height position of the downstream end portion of the correction portion is positioned below the height position of the downstream end portion of the placement portion, it is possible to inhibit a portion of the medium having a relatively low rigidity from passing over the lower end of the correction portion, and advancing in the movement direction.

In the medium loading device according to a sixth aspect, with respect to any one of the first to fifth aspects, the correction portion is provided to be displaceable between a correction position when the correction portion corrects the medium, and a retracted position when the correction portion is separated from the correction position with respect to the placement portion.

According to this aspect, when using the medium having the high rigidity in which the curling is unlikely to occur, by changing the position of the correction portion to a retracted position, the correction portion is not positioned in the movement direction of the medium. As a result, it is possible to inhibit the medium having the high rigidity from becoming caught up on the correction portion.

With respect to the sixth aspect, the medium loading device according to a seventh aspect includes a pressing member configured to press the correction portion downward in the device height direction.

When the medium having the relatively high rigidity comes into contact with the contact surface of the correction portion, the position of the correction portion may be shifted as a result of receiving a relatively strong pushing force from the medium.

Here, according to this aspect, the pushing force from the medium is resisted not only by a reaction force of the correction portion, but also by a pressing force of the pressing member. Thus, a positional shift of the correction portion can be suppressed.

With respect to the sixth or seventh aspect, the medium loading device according to an eighth aspect includes a driving portion configured to drive the correction portion to one of the correction position and the retracted position, and a control unit configured to control driving of the driving portion in accordance with the medium.

According to this aspect, by the control unit controlling the driving of the driving portion in accordance with the medium, the position of the correction portion is switched. Thus, when using the medium having the relatively low rigidity, the correction portion is not positioned at the retracted position.

In the medium loading device according to a ninth aspect, with respect to the eighth aspect, the control unit positions the correction portion at the correction position, when the medium is thin paper having a thickness thinner than a set thickness, and recording is performed on the medium, using a liquid, at a density higher than a set density.

According to this aspect, even when relatively significant curling is generated in the thin paper as a result of the thin paper swelling due to the liquid, since the correction portion is positioned at the correction position, the curling of the thin paper can be corrected.

In the medium loading device according to a tenth aspect, with respect to any one of the first to ninth aspects, the correction portion includes a plurality of the contact surfaces disposed at intervals in a medium width direction intersecting both the movement direction and the device height direction, and is configured to come into contact with both end portions of the medium in the medium width direction.

According to this aspect, when the medium having different sizes in the medium width direction is used, both end portions in the medium width direction of the medium, at which the curling is likely to occur, are brought into contact with the contact surface regardless of the size of the medium in the medium width direction. Thus, it is possible to prevent a situation in which the curling is not corrected when the size of the medium is changed.

In the medium loading device according to a eleventh aspect, with respect to any one of the first to tenth aspects, the contact surface extends linearly when viewed from a medium width direction intersecting both the movement direction and the device height direction.

According to this aspect, since the trajectory traced by the tip of the medium in the movement direction is straight rather than curved, that is, the trajectory is the shortest distance, it is possible to inhibit a movement path of the medium from becoming longer compared to a configuration in which the contact surface is curved when viewed from the medium width direction.

In the medium loading device according to a twelfth aspect, with respect to any one of the first to eleventh aspects, an inclined surface whose position in the device height direction becomes higher from upstream to downstream in the movement direction is formed at a section, of the placement portion, upstream of a downstream end portion of the placement portion in the movement direction.

According to this aspect, the medium discharged from the discharge unit is temporarily moved diagonally upward along the inclined surface. As a result, the medium is brought into an arrangement state in which a portion of the medium in the movement direction is formed in a mountain shape. In this way, the arrangement state of the medium becomes more stable with respect to a force acting in the movement direction, compared to a configuration in which the medium is in a linear shape in the movement direction. Thus, it is possible to inhibit the medium from falling off from the placement portion.

A recording system according to a thirteenth aspect includes a recording device and a medium loading device. The recording device includes a storage unit configured to store roll paper, a transport unit configured to transport the roll paper from the storage unit, a recording unit configured to perform recording on the roll paper transported by the transport unit, a cutting unit configured to cut the roll paper, on which recording was performed by the recording unit, to form a single paper sheet as a medium, and a discharge unit configured to discharge the single paper sheet. The medium loading device includes a placement portion on which at least one of the single paper sheets discharged from the discharge unit is placed, and a correcting portion disposed downstream of the placement portion in a movement direction of the single paper sheet at the placement portion, and configured to correct curling of the single paper sheet by coming into contact with the single paper sheet moving in the moving direction from the placement portion. The correction portion includes at least one contact surface extending in an intersecting direction intersecting the movement direction and configured to come into contact with the single paper sheet so that a position of the correction portion in a device height direction becomes lower from upstream toward downstream in the movement direction.

According to this aspect, the same effects as those of the first aspect can be obtained.

An example of a recording system and a medium loading device according to the present disclosure will be described below in detail.

In each of the drawings, an X direction along an X-axis is an example of a device width direction of a loading device 30, 90, 100, 110 described below, and of a medium width direction. A negative X direction is the leftward direction as viewed from a user when the user is facing the front face of the device, and a positive X direction is the rightward direction.

A Y direction along a Y-axis is an example of a device depth direction of the loading device 30, 90, 100, 110. A positive Y direction is a direction from the rear face toward the front face of the device, and is an example of a movement direction of a single paper sheet PS placed on a placement portion 42, which will be described below. A negative Y direction is a direction from the front face toward the rear face of the device. The X and Y directions are both horizontal directions.

A Z direction along a Z-axis is a device height direction of the loading device 30, 90, 100, 110 and the vertical direction. A positive Z direction is a vertically upward direction, and a negative Z direction is a vertically downward direction. The X direction, the Y direction, and the Z direction are orthogonal to each other.

A paper P is an example of a medium and a recording medium. In the following description, in order to make a distinction, the paper P in a rolled state will be referred to as roll paper PR, and the paper P cut into a sheet form will be referred to as the single paper sheet PS.

### First Embodiment

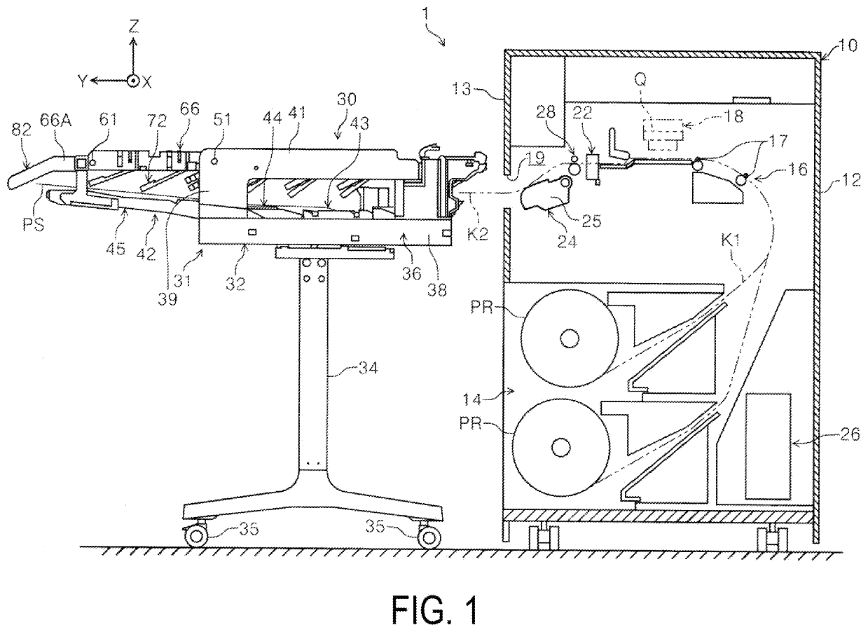

As illustrated in FIG. 1, a recording system 1 according to the first embodiment includes a printer 10 as an example of a processing device and a recording device, and a loading device 30 as an example of the medium loading device.

The printer 10 includes a cuboid-shaped housing 12. Further, as an example, the printer 10 is configured as an ink-jet type printer capable of performing printing on the paper P having a size ranging from an A4 size to an AO size.

Note that classification items of the paper P include not only the size, but also the bending rigidity of the paper P with respect to an external force acting in an out-of-plane direction of the paper P. Photo paper has a relatively high bending rigidity. Plain paper has a lower bending rigidity than that of the photo paper. In the printer 10, recording is possible on either the plain paper or the photo paper.

Specifically, the printer 10 includes, inside the housing 12, a storage unit 14, a transport unit 16, a recording unit 18, a cutting unit 22, and a discharge unit 24. Note that the printer 10 is provided with a control unit 26 configured to control operations of each of the units of the printer 10. As an example, the control unit 26 also functions as a control unit of the loading device 30 described below.

The housing 12 includes a sidewall 13 that constitutes a wall portion, in the positive Y direction, of the housing 12. A discharge port 19 that penetrates the sidewall 13 in the Y direction is formed in the sidewall 13. The discharge port 19 has a size that allows all sizes of the paper P usable in the printer 10 to pass through.

The storage unit 14 stores the roll paper PR that is rotated about a center axis along the X direction.

The transport unit 16 includes a plurality of transport rollers 17. Further, the transport unit 16 transports the roll paper PR pulled out from the storage unit 14 downstream along a transport path K1 indicated by an alternate long and two short dashes line.

The recording unit 18 performs recording on the roll paper PR transported by the transport unit 16, using an ink Q as an example of a liquid. Note that the roll paper PR is transported in the positive Y direction in a region facing the recording unit 18. Further, the recording unit 18 is positioned in the positive Z direction with respect to the roll paper PR. In other words, the recording is performed on the upper surface of the roll paper PR in the positive Z direction.

The cutting unit 22 cuts the roll paper PR recorded by the recording unit 18, to form the single paper sheet PS as the medium.

The discharge unit 24 includes a support 25 disposed downstream of the cutting unit 22, and a discharge roller pair 28. The support 25 supports the single paper sheet PS and guides the single paper sheet PS to the discharge port 19. The discharge roller pair 28 feeds the single paper sheet PS to the discharge port 19 via the support 25, thereby discharging the single paper sheet PS from the discharge port 19 to the outside. The single paper sheet PS discharged from the discharge port 19 is transported to the loading device 30 along a transport path K2 indicated by an alternate long and two short dashes line. Note that path constituting members (not illustrated) are disposed at the transport path K2.

Next, the loading device 30 will be described.

The single paper sheet PS discharged from the discharge unit 24 is loaded onto the loading device 30. Further, the loading device 30 includes a device main body 31 and correction portions 82 that correct the single paper sheet PS.

As an example, the device main body 31 is provided with a base portion 32, the placement portion 42 which is provided at the base portion 32 and on which the single paper sheet PS is placed, opposing portions 66 facing the placement portion 42 in the Z direction, and a pressing unit 72 that presses the single paper sheet PS.

The opposing portions 66 face the placement portion 42 while being disposed above the placement portion 42, namely, are disposed in the positive Z direction with respect to the placement portion 42. Further, as an example, five of the opposing portions 66 are provided at intervals in the X direction.

As an example, five of the correction portions 82 are provided at intervals in the X direction. Further, the correction portions 82 are provided at downstream end portions 66A, in the positive Y direction, of the opposing portions 66.

The base portion 32 includes a leg frame 34 that stands upright in the Z direction, casters 35 that are rotatably provided at end portions in the negative Z direction of the leg frame 34, and a support frame 36 that is provided at an end portion in the positive Z direction of the leg frame 34. Then, the base portion 32 supports the placement portion 42, the opposing portions 66, the pressing unit 72, and the correction portions 82 from the negative Z direction. In this way, the loading device 30 is movable in the positive Y direction and the negative Y direction.

The support frame 36 includes a lower frame 38 supported by the leg frame 34, wall portions 39 that stand upright in the positive Z direction from both ends in the X direction of the lower frame 38, and an upper frame 41 that connects end portions in the positive Z direction of the wall portions 39 in the X direction. Note that a column-shaped support shaft 51 extending along the X direction is provided at the upper frame 41.

At least one sheet of the single paper sheet PS discharged from the discharge section 24 is placed on the placement portion 42. A movement direction of the single paper sheet PS on the placement portion 42 is the positive Y direction as an example. As an example, the placement portion 42 is constituted by a first placement portion 43, a second placement portion 44, and a third placement portion 45 disposed in this order from upstream toward downstream in the positive Y direction.

The first placement portion 43 and the second placement portion 44 are supported directly by the base portion 32. The third placement portion 45 extends downstream from an end portion in the positive Y direction of the second placement portion 44, and is indirectly supported by the base portion 32 via the second placement portion 44.

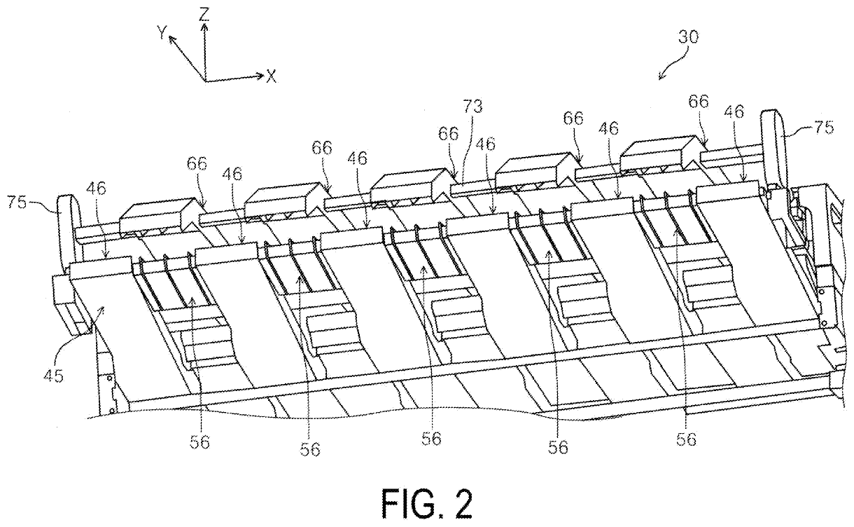

As illustrated in FIG. 2, as an example, the third placement portion 45 includes six main body portions 46 disposed at intervals in the X direction, and five coupling portions 56 that couple the six main body portions 46 in the X direction.

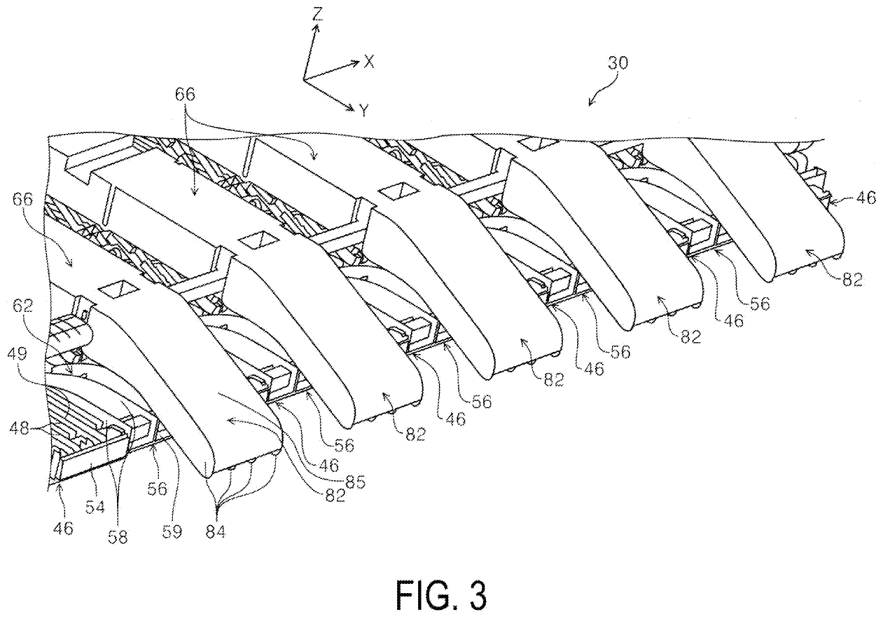

As illustrated in FIG. 3, as an example, the main body portion 46 is constituted by a plurality of vertical plates 48 disposed at intervals in the X direction and a front plate 54 that connects the plurality of vertical plates 48 in the X direction. The vertical plate 48 has a predetermined thickness in the X direction and is disposed along the Y-Z plane. Further, the vertical plate 48 extends in the positive Y direction. As an example, an upper surface 49 in the positive Z direction of the vertical plate 48 is included in a placement surface 62 described below and is configured similarly to the placement surface 62.

The front plate 54 has a predetermined thickness in the positive Y direction and is disposed along the X-Z plane. Further, the front plate 54 is formed in a rectangular shape having a dimension in the X direction greater than a dimension in the Z direction when viewed from the positive Y direction.

As an example, the coupling portion 56 is constituted by a plurality of vertical plates 58 disposed at intervals in the X direction and a bottom plate 59 that connects the plurality of vertical plates 58 in the X direction.

The vertical plate 58 has a predetermined thickness in the X direction and is disposed along the Y-Z plane. The interval in the X direction between the plurality of vertical plates 58 is wider than the interval in the X direction between the plurality of vertical plates 48. Further, the vertical plate 58 extends in the positive Y direction.

Note that the width in the X direction of the main body portion 46 and the width in the X direction of the coupling portion 56 are approximately the same.

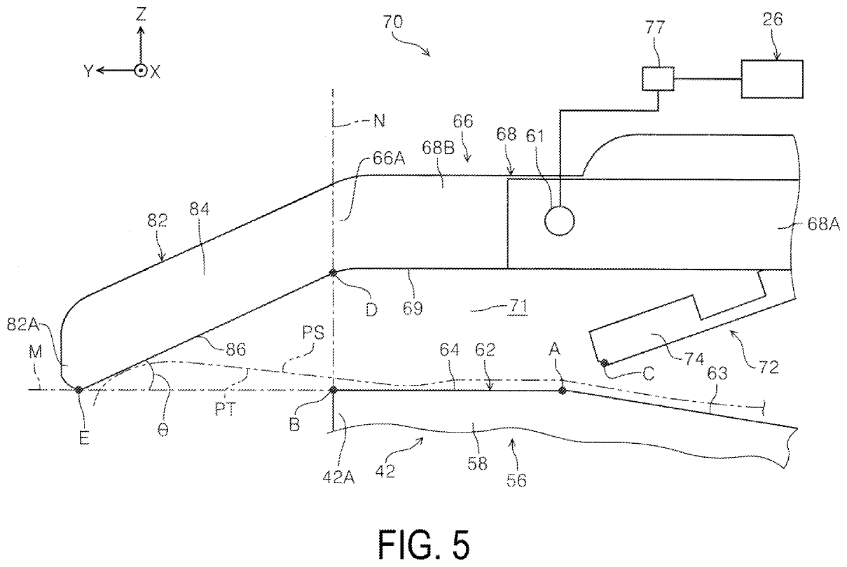

As illustrated in FIG. 5, the placement surface 62 is formed at an end portion in the positive Z direction of the vertical plate 58. The placement surface 62 includes an inclined surface 63 and a flat surface 64, as an example.

The inclined surface 63 is formed at a section upstream of a downstream end portion 42A in the positive Y direction of the placement portion 42. Further, the inclined surface 63 is positioned upstream of the flat surface 64. Specifically, the inclined surface 63 is a surface in which the position thereof becomes higher in the positive Z direction from upstream to downstream in the positive Y direction. In other words, the inclined surface 63 is a surface extending diagonally upward so that the height position in the Z direction of an end portion thereof in the positive Y direction is higher than the height position in the Z direction of an end portion thereof in the negative Y direction.

The flat surface 64 is a surface along the X-Y plane.

When viewed from the X direction, an intersection point between a line indicating the inclined surface 63 and a line indicating the flat surface 64 is defined as a point A. An end point in the positive Y direction of the flat surface 64 is defined as a point B. A straight line obtained by extending a line segment AB in the positive Y direction is defined as a lateral reference line M. A straight line passing through the point B and extending along the Z direction is defined as a vertical reference line N.

The five opposing portions 66 are supported by the upper frame 41 (FIG. 1) and extend from the upper frame 41 in the positive Y direction. Further, the five opposing portions 66 are disposed in the positive Z direction with respect to the placement portion 42. A section, of each of the five opposing portions 66, positioned further in the positive Y direction than the center thereof in the Y direction faces the coupling portion 56, but does not face the main body portion 46 (FIG. 3) in the Z direction.

The five opposing portions 66 are disposed so as to be symmetrical with respect to the center in the X direction. Further, of the five opposing portions 66, one in the positive X direction and one in the negative X direction are disposed at positions that can face both end portions in the X direction of the single paper sheet PS.

As an example, a second frame 68B, which will be described below, of the opposing portion 66 is integrated with the correction portion 82 described below. Thus, when viewed from the X direction, the opposing portion 66 refers to a portion positioned further in the negative Y direction than the vertical reference line N.

The position of the downstream end portion 66A in the positive Y direction of the opposing portion 66 is aligned with the position of the downstream end portion 42A in the positive Y direction of the placement portion 42.

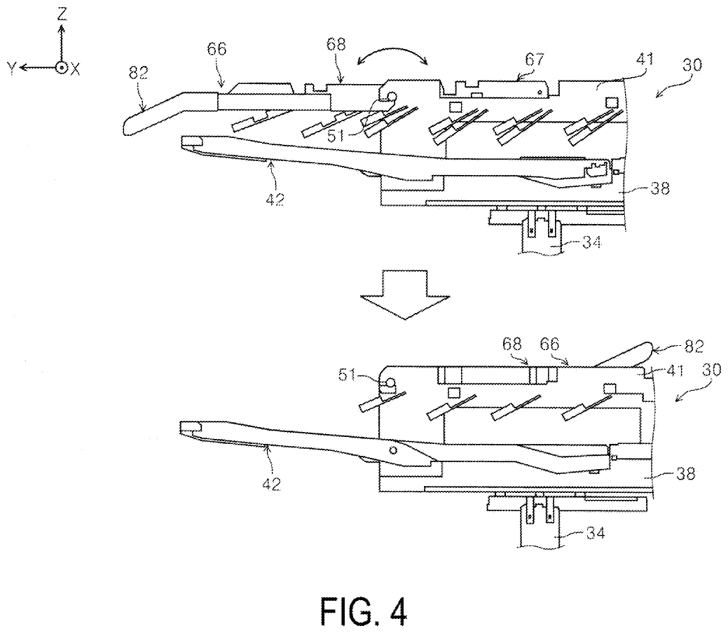

As illustrated in FIG. 2, the five opposing portions 66 are coupled to each other by a coupling rod 73 extending in the X direction. Gripping portions 75, which are gripped by the user, are provided on both end portions in the X direction of the coupling rod 73. The gripping portions 75 are used when a rotating portion 68 (FIG. 4), which will be described below, of the opposing portion 66 is rotated manually.

As illustrated in FIG. 4, the opposing portion 66 includes a fixed portion 67 and the rotating portion 68.

The fixed portion 67 is fixed to the upper frame 41 using a screw (not illustrated).

The rotating portion 68 is disposed downstream in the positive Y direction with respect to the fixed portion 67. An end portion in the negative Y direction of the rotating portion 68 is coupled to the support shaft 51 of the upper frame 41. As a result, the rotating portion 68 is rotatable about the support shaft 51. The rotating portion 68 rotated toward the upper frame 41 is stored in the upper frame 41. When the length of the single paper sheet PS to be placed is short, by storing the rotating portion 68 in the upper frame 41, the single paper sheet PS is easily removed from the placement portion 42.

In the state in which the rotating portion 68 is stored, a portion of the rotating portion 68 is engaged with an engaging portion (not illustrated), and thus the rotation is regulated. As a result, the rotating portion 68 is held in a posture along the Y direction.

As illustrated in FIG. 5, as an example, a lower surface 69 in the negative Z direction of the opposing portion 66 is a flat surface along the X-Y plane. The size of a space 71 between the lower surface 69 and the placement surface 62 in the Z direction is set to a size that allows the single paper sheet PS of each size to move in the positive Y direction. Further, the size of the space 71 is preset so that the single paper sheet PS in a curled state does not come into contact with the lower surface 69. In other words, the lower surface 69 is not configured to correct curling of the single paper sheet PS.

Note that, as an example, the rotating portion 68 includes a first frame 68A that is rotatably coupled to the support shaft 51, and a second frame 68B that is rotatably coupled to the first frame 68A via a rotational movement shaft 61.

The pressing unit 72 is constituted by a plurality of pressing members 74 provided at the opposing portions 66 at intervals in the Y direction. Note that in FIG. 5, the pressing member 74 positioned at the most downstream position in the positive Y direction is illustrated.

The pressing member 74 extends diagonally downward from the opposing portion 66 so that a downstream end thereof in the positive Y direction is positioned further in the negative Z direction than an upstream end thereof. One end portion in the extending direction of the pressing member 74 is rotatably coupled to the opposing portion 66. A roller (not illustrated) is rotatably supported by a tip portion of the pressing member 74, that is, another end portion in the extending direction of the pressing member 74. The outer circumferential surface of the roller can come into contact with the upper surface of the single paper sheet PS that is positioned furthest in the positive Z direction, of the loaded single paper sheets PS.

When viewed from the X direction, a position corresponding to the lower end of the pressing member 74 is defined as a point C. The point C is positioned upstream of the point A in the positive Y direction.

When a loaded amount of the loaded single paper sheets PS changes, the pressing member 74 swings and changes the height position thereof in the Z direction. Note that the pressing member 74 is not configured to correct curling of both the end portions in the X direction of the single paper sheet PS.

The correction portion 82 is disposed downstream of the placement portion 42 in the positive Y direction of the single paper sheet PS on the placement portion 42. Further, the correction portion 82 is provided for each of the opposing portions 66 at intervals in the X direction.

Specifically, the correction portion 82 is provided at the downstream end portion 66A in the positive Y direction of the opposing portion 66. In other words, the correction portion 82 is provided at the rotating portion 68.

The correction portion 82 is a portion that extends diagonally downward from the downstream end portion 66A, and the height position of the correction portion 82 in the Z direction becomes lower as the correction portion 82 extends further downstream in the positive Y direction. Furthermore, the correction portion 82 is a portion disposed downstream of the vertical reference line N in the positive Y direction. Then, the correction portion 82 comes into contact with a portion of the single paper sheet PS that moves from the placement portion 42 in the positive Y direction, in order to correct the curling of the single paper sheet PS.

As illustrated in FIG. 3, as an example, the correction portion 82 is constituted by four correction plates 84 disposed at intervals in the X direction and an upper plate 85 that covers the four correction plates 84 from the positive Z direction and connects the four correction plates 84 in the X direction. Each of the four correction plates 84 includes a contact surface 86 (FIG. 5) that comes into contact with the single paper sheet PS. In other words, the correction portion 82 includes four of the contact surfaces 86. The four contact surfaces 86 are disposed at intervals in the X direction that is orthogonal to both the positive Y direction and the Z direction, and come into contact with both the end portions in the X direction of the single paper sheet PS. Note that, in the following description, one of the contact surfaces 86 will be described, and a description of the remaining three contact surfaces 86 will be omitted.

As illustrated in FIG. 5, the contact surface 86 extends in an intersecting direction that intersects the positive Y direction, so that the position thereof in the Z direction becomes lower from upstream to downstream in the positive Y direction. Furthermore, when viewed from the X direction, the contact surface 86 extends in a linear manner. In other words, the four contact surfaces 86 are inclined surfaces.

When viewed from the X direction, an upstream end point in the positive Y direction of the contact surface 86 is defined as a point D. The point D is on the vertical reference line N. Further, a downstream end point in the positive Y direction of the contact surface 86 is defined as a point E. The point E is a point corresponding to the lower end in the Z direction of the correction plate 84. The contact surface 86 is indicated by a line segment DE.

Both the point B and the point E are on the lateral reference line M. In other words, the height of the flat surface 64 and the height of the downstream end of the contact surface 86 are aligned to the same height. In other words, in the Z direction, the height position of a portion of the downstream end portion 82A in the positive Y direction of the correction portion 82 is aligned with the height position of the downstream end portion 42A in the positive Y direction of the placement portion 42.

An angle BED is an inclination angle θ of the correction portion 82. As an example, the inclination angle θ is 20 degrees. The inclination angle θ can be set within a range capable of correcting the curling of the single paper sheet PS, but it is preferable that the inclination angle θ be selected within a range from 15 degrees to 40 degrees in order to allow the paper P having a relatively high rigidity to move, and to inhibit the size of the loading device 30 in the Y direction from becoming large. Note that the length of a line segment BE is 100 mm, as an example.

Next, effects of the recording system 1 and the loading device 30 according to the first embodiment will be described. Note that it is assumed that each configuration of the recording system 1 and the loading device 30 is described below with reference to FIG. 1 to FIG. 5, so reference to individual drawing numbers will be omitted.

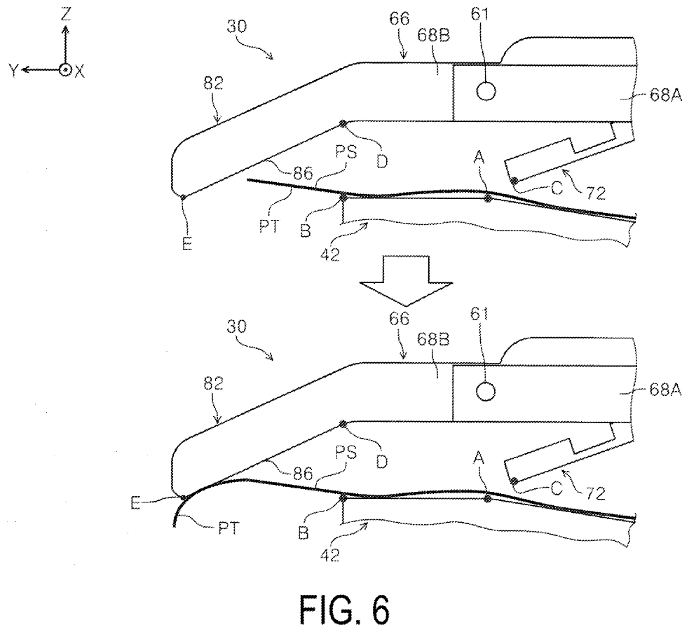

As illustrated in FIG. 6, in the loading device 30, a case will be described, as an example, in which the thin single paper sheet PS on which high density recording has been performed moves on the placement portion 42. Note that the size of the single paper sheet PS is a size that causes the single paper sheet PS to protrude from the placement surface 62 in the positive Y direction. In other words, in a state in which the single paper sheet PS is placed on the placement surface 62, a downstream portion in the positive Y direction of the single paper sheet PS protrudes in the positive Y direction from the placement surface 62.

Here, the single paper sheet PS is in an expanded state in which the ink Q (FIG. 1) permeates the single paper sheet PS due to the recording. Thus, a state may be obtained in which both the end portions in the X direction of the single paper sheet PS are curled up, namely, are positioned further in the positive Z direction than a central portion of the single paper sheet PS. Then, as a result of the single paper sheet PS, for which both the end portions in the X direction are curled up, being moved in the positive Y direction in that state, the single paper sheet PS comes into contact with the contact surface 86 of the correction portion 82.

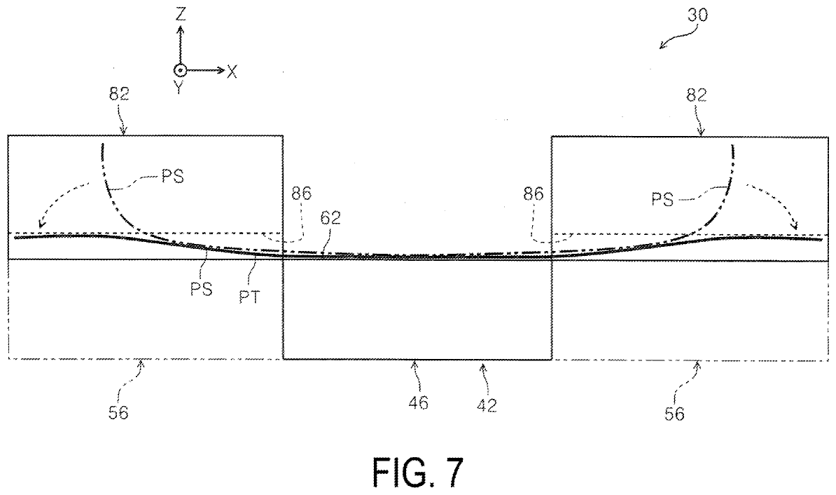

FIG. 7 is a schematic view illustrating a state of a portion of the placement portion 42 and portions of the correction portions 82 as viewed from the positive Y direction. Note that in order to clearly illustrate a state of the single paper sheet PS, the single paper sheet PS is illustrated in a transparent state. The single paper sheet PS indicated by an alternate long and two short dashes line represents the single paper sheet PS in the curled state in which both the end portions thereof in the X direction are curled up. The single paper sheet PS indicated by a solid line represents the single paper sheet PS for which the curling has been corrected by the correction portions 82.

Of the single paper sheet PS, portions protruding in the positive Y direction from the placement portion 42 come into contact with the contact surfaces 86. Here, since both the end portions in the X direction of the single sheet paper PS are brought into contact with the contact surfaces 86, the curling-up of both the end portions of the single sheet paper PS is corrected so as to be as flat as possible along the X direction. In other words, the single paper sheet PS indicated by the alternate long and two short dashes line is shaped into the single paper sheet PS indicated by the solid line. As a result, when both the end portions of the single paper sheet PS hang down under their own weight, both the end portions are inhibited from being formed into a bag-shape and becoming folded over.

When a plurality of the single paper sheets PS are loaded on the placement portion 42, the single paper sheet PS that is loaded onto the single paper sheet PS already placed on the placement surface 62 is discharged onto the already corrected single paper sheet PS. As a result, both the end portions of the subsequently loaded single paper sheet PS are inhibited from becoming caught up on the already placed single paper sheet PS. In other words, a stacking failure of the single paper sheet PS in the loading device 30 is suppressed.

As described above, according to the loading device 30, when a portion of the single paper sheet PS moving on the placement portion 42 is brought into the curled state in which the portion of the single paper sheet PS is curled up in the Z direction, and protrudes further downstream than the placement portion 42, the portion of the single paper sheet PS comes into contact with the contact surface 86 of the correction portion 82. Here, since the contact surface 86 extends in the intersecting direction so that the position thereof in the Z direction becomes lower from upstream to downstream in the positive Y direction, the portion of the single paper sheet PS that has come into contact with the contact surface 86 is corrected in a direction opposite to the curling-up direction. As a result, when the portion of the single paper sheet PS protruding from the placement portion 42 hangs down under its own weight, the portion of the single paper sheet PS is inhibited from becoming folded over. Thus, when the next single paper sheet PS is placed on the placement portion 42, it is possible to suppress the stacking failure in which the next single paper sheet PS becomes caught up on the previous single paper sheet PS.

Furthermore, according to the loading device 30, the stacking failure of the single paper sheet PS can be suppressed even when the length in the positive Y direction of the placement portion 42 is caused to be shorter than the length in the positive Y direction of the single paper sheet PS. Thus, the placement portion 42 can be downsized.

According to the loading device 30, by providing the correction portions 82 at the opposing portions 66 of the device main body 31, the correction portions 82 are supported by the opposing portions 66. Thus, it is not necessary to separately prepare a member for supporting the correction portions 82.

According to the loading device 30, the position of the downstream end portion 42A of the placement portion 42 and the position of the downstream end portion 66A of the opposing portion 66 are aligned in the positive Y direction. As a result, the portion of the single paper sheet PS protruding from the placement portion 42 does not come into contact with the opposing portions 66, but comes into contact with the correction portions 82. As a result, the curling can be corrected at an early stage with respect to the portion of the single paper sheet PS protruding from the placement portion 42.

According to the loading device 30, the height position of the downstream end portion 82A of the correction portion 82 is aligned with the height position of the downstream end portion 42A of the placement portion 42. Thus, when the single paper sheet paper PS having the relatively high rigidity in which curling is unlikely to occur is discharged and the single paper sheet PS is moved downstream from the placement portion 42 in a substantially straight manner, even if the single paper sheet PS comes into contact with the correction portions 82, the single paper sheet PS easily passes over the correction portions 82. In other words, when the single paper sheet PS having the relatively high rigidity is used, it is possible to inhibit the single paper sheet PS from becoming caught up on the correction portions 82.

According to the loading device 30, when using the single paper sheet PS in which the curling is unlikely to occur, by changing the position of the correction portions 82 to a retracted position, the correction portions 82 are not positioned in the positive Y direction of the single paper sheet PS. As a result, it is possible to inhibit the single paper sheet PS having the high rigidity from becoming caught up on the correction portions 82. According to the loading device 30, when the single sheet paper PS having different sizes in the X direction is used, both the end portions in the X direction of the single paper sheet PS, at which the curling is likely to occur, are brought into contact with the contact surfaces 86 regardless of the size of the single paper sheet PS in the X direction. Thus, it is possible to prevent a situation in which the curling is not corrected when the size of the single paper sheet PS is changed.

According to the loading device 30, since the trajectory traced by the tip of the single paper sheet PS in the positive Y direction is straight rather than curved, that is, the trajectory is the shortest distance, it is possible to inhibit a movement path of the single paper sheet PS from becoming longer compared to a configuration in which the contact surfaces 86 are curved when viewed from the X direction.

According to the loading device 30, the single paper sheet PS discharged from the discharge unit 24 is temporarily moved diagonally upward along the inclined surface 63. As a result, the single paper sheet PS is brought into an arrangement state in which a portion of the single paper sheet PS in the positive Y direction is formed in a mountain shape. In this way, the arrangement state of the single paper sheet PS becomes more stable with respect to a force acting in the positive Y direction, compared to a configuration in which the single paper sheet PS is in a linear shape in the positive Y direction. Thus, it is possible to inhibit the single paper sheet PS from falling off from the placement portion 42.

According to the printer 10, effects similar to those of the loading device 30 can be obtained.

Next, a loading device 70, which is a modified example of the loading device 30, will be described. Note that portions common to those of the loading device 30 according to the first embodiment will be denoted by the same reference signs, and a description thereof will be omitted. Further, the loading device 70 is an example of the medium loading device, and is provided in the printer 10 according to the first embodiment instead of the loading device 30. Thus, a description of the printer 10 will be omitted.

The correction portion 82 is provided so that the position of the correction portion 82 can be switched between a correction position and the retracted position. In other words, as a result of the correction portion 82 rotating, the position of the correction portion 82 is switched from one of the correction position and the retracted position to the other position.

The correction position is a position of the correction portion 82 when the correction portion 82 corrects the curling of the single paper sheet PS.

The retracted position is a position of the correction portion 82 when the correction portion 82 is separated from the correction position.

As illustrated in FIG. 5, the loading device 70 includes the rotational movement shaft 61 that rotatably supports the second frame 68B and the correction portions 82, at a position at an end portion in the positive Y direction of the first frame 68A. The loading device 70 includes a motor 77 and the control unit 26.

A gear (not illustrated) is attached to an end portion in the positive X direction of the rotational movement shaft 61.

The motor 77 is an example of a driving portion that drives the correction portions 82 to one of the correction position and the retracted position by driving the second frame 68B with respect to the first frame 68A. Further, the motor 77 rotates the gear provided at the end portion in the positive X direction of the rotational movement shaft 61. Driving of the motor 77 is controlled by the control unit 26.

When a rotation button (not illustrated) is operated, the control unit 26 operates the motor 77 to change the position of the correction portions 82 to the retracted position. Further, when an advance button (not illustrated) is operated, the control unit 26 operates the motor 77 to change the position of the correction portions 82 to the correction position.

The control unit 26 may control the driving of the motor 77 in accordance with the type and size of the paper P. The type of the paper P includes a material and the thickness. The size of the paper P means the longitudinal dimension and the lateral dimension when the paper P is viewed from an out-of-plane direction.

Specifically, when the size of the paper P is small, the control unit 26 performs control to position the correction portions 82 at the retracted position, and when the size of the paper P is large, the control unit 26 performs control to position the correction portions 82 at the correction position.

Further, when the paper P is thin paper having a thinner thickness than a set thickness and recording having a higher density than a set density is performed on the paper P using the ink Q, the control unit 26 performs the control to position the correction portions 82 at the correction position. The high density recording means that the recording is performed such that the image density of an image recorded on the paper P becomes higher than the set density.

When the paper P is thick paper that is thicker than the thin paper, the control unit 26 performs the control to position the correction portions 82 at the retracted position. Furthermore, when the paper P is photo paper, the control unit 26 performs the control to position the correction portions 82 at the correction position.

According to the loading device 70, by the control unit 26 controlling the driving of the motor 77 in accordance with the single paper sheet PS, the position of the correction portions 82 is switched. Thus, when using the single paper sheet PS having the relatively low rigidity, the correction portions 82 are not positioned at the retracted position.

According to the loading device 70, even when relatively significant curling is generated in the thin paper as a result of the thin paper swelling due to the ink Q, since the correction portions 82 are positioned at the correction position, the curling of the thin paper can be corrected.

### Second Embodiment

Next, a loading device 90 according to a second embodiment, which is an example of the medium loading device, will be described with reference to the accompanying drawings. Note that portions common to those of the loading device 30 according to the first embodiment will be denoted by the same reference signs, and a description thereof will be omitted. Further, the loading device 90 is provided in the printer 10 according to the first embodiment instead of the loading device 30. Thus, the description of the printer 10 will be omitted.

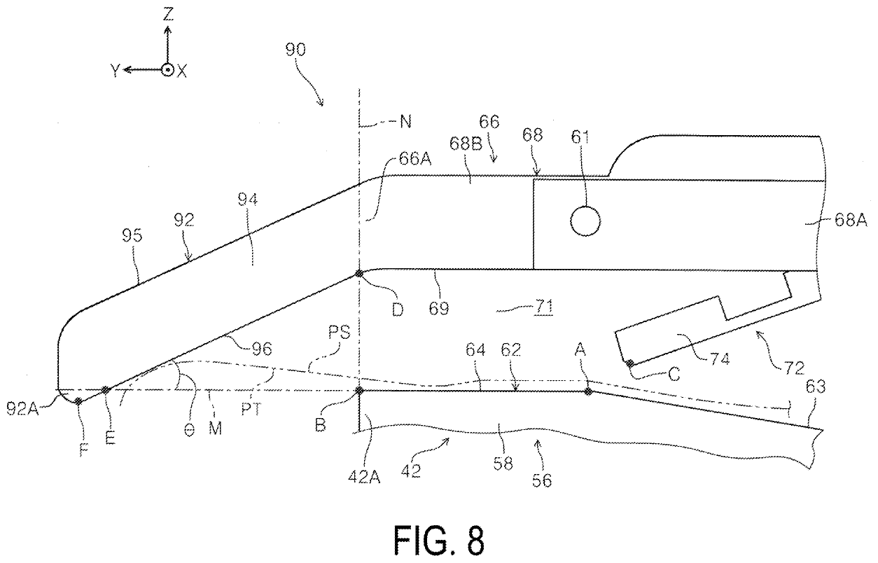

The loading device 90 is illustrated in FIG. 8. The loading device 90 includes correction portions 92 instead of the correction portions 82 (FIG. 5) in the loading device 30 (FIG. 5). Note that, in the loading device 90, portions other than the correction portion 92 are the same as and common to those of the loading device 30.

The correction portion 92 extends from the downstream end portion 66A of the opposing portion 66 to a position further in the negative Z direction than the lateral reference line M. In other words, in the Z direction, the height position of a downstream end portion 92A in the positive Y direction of the correction portion 92 is positioned below the height position of the downstream end portion 42A of the placement portion 42. Note that the height position of the downstream end portion 92A corresponds to the position of the lower end in the Z direction of the correction portion 92.

Specifically, the correction portion 92 is constituted by four correction plates 94 disposed at intervals in the X direction and an upper plate 95 that covers the four correction plates 94 from the positive Z direction and connects the four correction plates 94 in the X direction. Each of the four correction plates 94 includes a contact surface 96 that comes into contact with the single paper sheet PS. In other words, the correction portion 92 includes four of the contact surfaces 96. Note that in FIG. 8, one of the correction portions 92 is illustrated.

The four contact surfaces 96 are disposed at intervals in the X direction that is orthogonal to both the positive Y direction and the Z direction, and come into contact with both the end portions of the single paper sheet PS in the X direction. Further, the four contact surfaces 96 extend in the intersecting direction that intersects the positive Y direction, so that the positions thereof in the Z direction become lower from upstream to downstream in the positive Y direction. Furthermore, the four contact surfaces 96 extend linearly when viewed from the X direction. In other words, the four contact surfaces 96 are inclined surfaces.

When viewed from the X direction, an upstream end point in the positive Y direction of the contact surface 96 is defined as the point D. The point D is on the vertical reference line N. Further, a downstream end point in the positive Y direction of the contact surface 96 is defined as a point F. The point F is a point corresponding to the lower end in the Z direction of the correction plate 94. Furthermore, the point F is positioned in the positive Y direction and the negative Z direction with respect to the point E. The contact surface 96 is represented by a line segment DF.

When viewed from the X direction, as an example, an inclination angle of the contact surface 96 with respect to the X-Y plane is defined as the inclination angle θ described above.

Next, an effect of the loading device 90 will be described.

According to the loading device 90, since the height position of the downstream end portion 92A of the correction portion 92 is positioned below the height position of the downstream end portion 42A of the placement portion 42, it is possible to inhibit a portion of the single paper sheet PS having the relatively low rigidity from passing over the lower end in the Z direction of the correction portion 92, and advancing in the positive Y direction.

### Third Embodiment

Next, a loading device 100 according to a third embodiment, which is an example of the medium loading device, will be described with reference to the accompanying drawings. Note that portions common to those of the loading devices 30, 90 will be denoted by the same reference signs, and a description thereof will be omitted. Further, the loading device 100 is provided in the printer 10 according to the first embodiment instead of the loading device 30. Thus, the description of the printer 10 will be omitted.

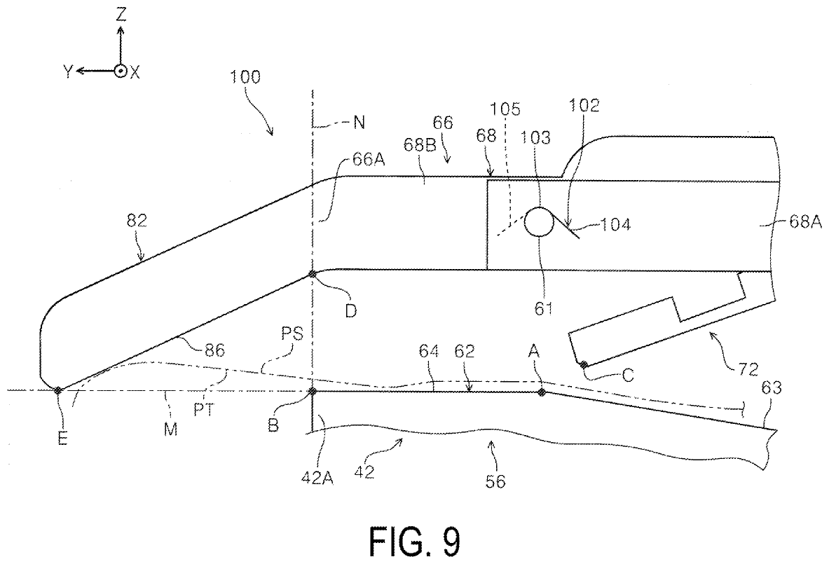

The loading device 100 is illustrated in FIG. 9. The loading device 100 has a configuration obtained by removing the motor 77 (FIG. 5) and providing a torsion spring 102 at the rotational movement shaft 61 in the loading device 30 (FIG. 5). In other words, the loading device 100 has a configuration in which the correction portions 82 are manually rotated. Further, the loading device 100 is provided with a button (not illustrated). When the correction portions 82 are manually rotated, by causing the button to be in a pressed state, a pressing force of the torsion spring 102, which will be described below, is released, and the correction portions 82 become rotatable.

The torsion spring 102 is an example of a pressing member, and presses the correction portions 82 downward in the Z direction. Specifically, the torsion spring 102 includes a winding wire portion 103, a first arm portion 104, and a second arm portion 105. The rotational movement shaft 61 is inserted into the winding wire portion 103.

The first arm portion 104 extends in a first direction from one end of the winding wire portion 103. Further, a portion of the first arm portion 104 is attached to the first frame 68A.

The second arm portion 105 extends in a second direction different from the first direction, from the other end of the winding wire portion 103. Further, a portion of the second arm portion 105 is attached to the second frame 68B.

In this way, by being attached around the rotational movement shaft 61, the torsion spring 102 presses the correction portions 82 downward in the Z direction.

Note that a stopper (not illustrated) is provided at the first frame 68A so that the second frame 68B is not rotated more than necessary.

Next, effects of the loading device 100 will be described.

When the single paper sheet PS having the relatively high rigidity comes into contact with the contact surfaces 86 of the correction portion 82, the position of the correction portion 82 may be shifted as a result of receiving a relatively strong pushing force from the single paper sheet PS.

Here, according to the loading device 100, the pushing force from the single paper sheet PS is resisted not only by a reaction force generated by the correction portion 82 under its own weight, but also by the pressing force of the torsion spring 102. Thus, the positional shift of the correction portion 82 can be suppressed.

Further, as in the second embodiment, in a configuration in which the correction portion 82 extends from the downstream end portion 66A of the opposing portion 66 to a position further in the negative Z direction than the lateral reference line M, when causing the single paper sheet PS having the high rigidity and no need for correction to pass over the position of the correction portion 82, since the single paper sheet PS has the rigidity, the single paper sheet paper PS can be caused to pass over the correction portion 82 by the single paper sheet PS pushing aside the correction portion 82 in the positive Y direction in resistance to the weight of the correction portion 82, or in resistance to the weight of the correction portion 82 and the pressing force of the torsion spring 102.

Although the printer 10 and the loading devices 30, 70, 90, 100 according to the first to third embodiments of the present disclosure are based on such configurations as described above, as a matter of course, modifications, omissions, and the like may be made to a partial configuration without departing from the gist of the disclosure of the present application.

### Modified Example

Next, a loading device 110, which is a modified example of the loading device 90 according to the second embodiment, will be described with reference to the accompanying drawings. Note that portions common to those of the loading devices 90 will be denoted by the same reference signs, and a description thereof will be omitted.

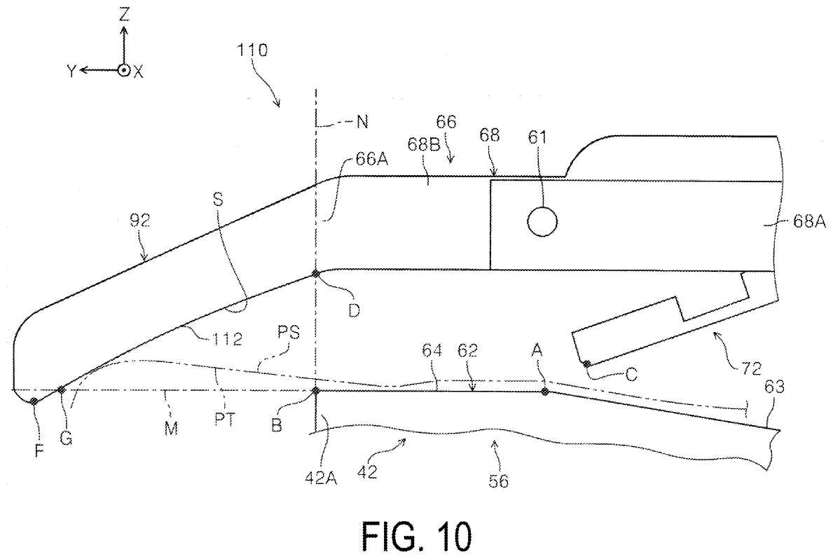

The loading device 110 is illustrated in FIG. 10. The loading device 110 includes a contact surface 112 instead of the contact surface 96 (FIG. 8) in the loading device 90 (FIG. 8).

The contact surface 112 is a curved surface, and is indicated by a curved line S that is recessed toward a position in the positive Y direction and the positive Z direction, when viewed from the X direction. An intersection point between the curved line S and the lateral reference line M is defined as a point G. In other words, the curved line S is formed from the point D to the point F, and the point G is positioned between the point D and the point F on the curved line S. In this way, by forming the contact surface 112 as the curved surface, compared to a configuration in which the contact surface 112 is an inclined surface, a timing at which the single paper sheet PS comes into contact with the contact surface 112 can be delayed. Thus, it is possible to inhibit the single paper sheet PS from coming into contact with the contact surface 112 at an early timing and hanging down in the negative Z direction.

### Other Modified Examples

In the loading device 30, the correction portion 82 may be provided at a location other than the opposing portion 66 in the device main body 31. For example, the correction portion 82 may be supported by the base portion 32. Further, the correction portion 82 may be supported by a central portion or an upstream portion in the positive Y direction of the opposing portion 66.

The rotating portion 68 may only be rotated manually, without using the motor 77.

A configuration may be adopted in which the opposing portion 66 is constituted by the fixing portion 67 only, and the correction portion 82 is positioned at the correction position only.

The position of the downstream end portion 66A need not necessarily be aligned with the position of the downstream end portion 42A.

In the loading device 30, when the single paper sheet PS is the thin paper, the correction portion 82 may be positioned at the correction position regardless of the density of the recording.

The correction portion 82 may be configured as a single portion extending in the X direction. Accordingly, the contact surface 86 may be one surface. Further, the contact surface 86 may be a curved surface when viewed from the X direction.

The placement surface 62 may be constituted by the flat surface 64 only.

Note that, in the same manner as with the loading device 30, each of the loading devices 70, 90, 100, 110 can also be configured in a manner that excludes a part of the configuration thereof.

The recording unit 18 may be a serial recording head or a line head. The processing device is not limited to the ink-jet type printer 10, and may be an electrophotographic printer. Furthermore, the processing device is not limited to a printer, and may be, for example, a device that performs coating on a surface of a medium.

An alignment method of the paper P in the loading device 30, 90, 100, 110 is not limited to a center resist method in which the center in the X direction of the device is aligned with the center of the paper P, but may be a side resist method in which the paper P is arranged while being aligned against a side in the positive X direction or the negative X direction.

What is claimed is:

1. A medium loading device on which is loaded a medium discharged from a discharge unit of a processing device, the medium loading device comprising:
a placement portion provided at a device main body and on which at least one sheet of the medium discharged from the discharge unit is placed; and
a correction portion disposed downstream of the placement portion in a movement direction, at the placement portion, of the medium, and configured to correct curling of the medium by coming into contact with the medium moving in the movement direction from the placement portion, wherein
the correction portion includes at least one contact surface extending in an intersecting direction intersecting the movement direction and configured to come into contact with the medium so that a position of the correction portion in a device height direction becomes lower from upstream toward downstream in the movement direction.

2. The medium loading device according to claim 1, wherein
the device main body includes an opposing portion disposed above the placement portion in the device height direction and facing the placement portion, and
the correction portion is provided at the opposing portion.

3. The medium loading device according to claim 2, wherein
a position of a downstream end portion of the opposing portion in the movement direction is aligned with a position of a downstream end portion of the placement portion in the movement direction, and
the correction portion is provided at a downstream end of the opposing portion in the movement direction.

4. The medium loading device according to claim 1, wherein
in the device height direction, a height position of a downstream end portion of the correction portion in the movement direction is aligned with a height position of a downstream end portion of the placement portion in the movement direction.

5. The medium loading device according to claim 1, wherein
in the device height direction, a height position of a downstream end portion of the correction portion in the movement direction is positioned below a height position of a downstream end portion of the placement portion in the movement direction.

6. The medium loading device according to claim 1, wherein
the correction portion is provided to be displaceable between a correction position for correcting the medium, and a retracted position where the correction portion is separated from the correction position with respect to the placement portion.

7. The medium loading device according to claim 6, comprising:
a pressing member configured to press the correction portion downward in the device height direction.

8. The medium loading device according to claim 6, comprising:
a driving portion configured to drive the correction portion to one of the correction position and the retracted position; and
a control unit configured to control driving of the driving portion in accordance with the medium.

9. The medium loading device according to claim 8, wherein
the control unit positions the correction portion at the correction position, when the medium is thin paper having a thickness thinner than a set thickness, and recording is performed on the medium, using a liquid, at a density higher than a set density.

10. The medium loading device according to claim 1, wherein
the correction portion includes a plurality of the contact surfaces disposed at intervals in a medium width direction intersecting both the movement direction and the device height direction, and is configured to come into contact with both end portions of the medium in the medium width direction.

11. The medium loading device according to claim 1, wherein
the contact surface extends linearly when viewed from a medium width direction intersecting both the movement direction and the device height direction.

12. The medium loading device according to claim 1, wherein
an inclined surface is formed at a section, of the placement portion, upstream of a downstream end portion of the placement portion in the movement direction, and a position, in the device height direction, of the inclined surface becomes higher from upstream toward downstream in the movement direction.

13. A recording system including a recording device and a medium loading device, wherein
the recording device includes
a storage unit configured to store roll paper,
a transport unit configured to transport the roll paper from the storage unit,
a recording unit configured to perform recording on the roll paper transported by the transport unit,
a cutting unit configured to cut the roll paper, on which recording was performed by the recording unit, to form a single paper sheet as a medium, and
a discharge unit configured to discharge the single paper sheet,
the medium loading device includes
a placement portion on which at least one of the single paper sheets discharged from the discharge unit is placed, and
a correcting portion disposed downstream of the placement portion in a movement direction of the single paper sheet at the placement portion, and configured to correct curling of the single paper sheet by coming into contact with the single paper sheet moving in the moving direction from the placement portion, and
the correction portion includes at least one contact surface extending in an intersecting direction intersecting the movement direction and configured to come into contact with the single paper sheet so that a position of the correction portion in a device height direction becomes lower from upstream toward downstream in the movement direction.
